(19) United States
(12) Patent Application Publication
(10) Pub. No.: US 2025/0141018 A1
(43) Pub. Date: May 1, 2025

(54) EXPANDABLE PORTABLE POWER SUPPLY

(71) Applicant: OXTI Pte Ltd, Singapore (SG)

(72) Inventor: Chih-Feng Ho, Singapore (SG)

(21) Appl. No.: 18/498,062

(22) Filed: Oct. 31, 2023

(51) Int. Cl. H01M 50/258; H01M 50/264

(52) U.S. Cl. CPC H01M 50/258; H01M 50/264; H01M 2220/30

(57) ABSTRACT

The expandable portable power supply includes a first power source and a second power source disposed to a side of the first power source. The first power source includes a first casing having a first power connection member and a first coupling member. The second power source includes a second casing having a second power connection member and a second coupling member. When the first and second power sources are aligned and attached, the first and second power connection members are contacted, and the first and second coupling members are matched and joined. As such, the first and second power sources can have their respective power capacities combined to provide electricity to electronic devices for an extended period of time. The first and second power sources may be detached for easy transportation and replacement, especially convenient for camping, travel, or other outdoor activity.

### BACKGROUND OF THE INVENTION

### (a) Technical Field of the Invention

The present invention is generally related to portable power supplies, and more particularly to an expandable portable power supply.

### (b) Description of the Prior Art

R.O.C. Taiwan Patent No. M641959 discloses a multi-functional portable power supply, as shown in the patent's FIG. 1, which includes a casing, a control circuit board, magnets, a battery core, a light, a Type-C interface, a USB interface, and a solar panel interface. The battery core, light, Type-C interface, USB interface, and solar panel interface are all electrically connected to the control circuit board. The light, Type-C interface, USB interface, and solar panel interface are securely fixed on the outer side of the casing, while the battery core and magnets are fixed inside the casing.

This conventional portable power supply, although convenient for carrying, has limited power capacity and cannot provide sufficient power for multiple electronic devices or high-power-consuming electronic devices for an extended period. When the power capacity is depleted, the electronic devices automatically shut down and stop working. Therefore, there is a need to further improve upon the limited capacity of the conventional portable power supply.

### SUMMARY OF THE INVENTION

To achieve the above objective, an expandable portable power supply is disclosed, which includes a first power source and a second power source disposed to a side of the first power source. The first power source includes a first casing, and the first casing has a first power connection member and a first coupling member. The second power source includes a second casing, and the second casing has a second power connection member and a second coupling member. When the first power source and the second power source are aligned and attached, the first power connection member and the second power connection member are contacted, and the first coupling member and the second coupling member are matched and joined.

The expandable portable power supply may further include at least one expansion power source sandwiched between the first power source and the second power source. The expansion power source includes an expansion casing having a third power connection member and a third coupling member on a first side, and a fourth power connection member and a fourth coupling member on a second side.

The first power connection member includes a first positive connection element and a first negative connection element, and the second power connection member includes a second positive connection element and a second negative connection element.

Each of the first coupling member, the second coupling member, the third coupling member, and the fourth coupling member includes a number of magnetic elements, buckling elements, screw fastening elements, or adhesive elements.

The first casing of the first power source further has a first display panel and a first power source output element, and the second casing of the second power source further has a second display panel and a second power source output element.

The first and second power sources can have their respective power capacities combined to provide electricity to electronic devices for an extended period of time. The first and second power sources may be detached for easy transportation and replacement, especially convenient for camping, travel, or other outdoor activity.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an expandable portable power supply according to a first embodiment of the present invention.

FIG. 2 is a perspective breakdown diagram showing the expandable portable power supply of FIG. 1.

FIG. 3 is another perspective breakdown diagram showing the expandable portable power supply of FIG. 1.

FIG. 4 is a perspective diagram showing an expandable portable power supply according to a second embodiment of the present invention.

FIG. 5 is a perspective breakdown diagram showing the expandable portable power supply of FIG. 4.

FIG. 6 is a perspective diagram showing an expandable portable power supply according to a third embodiment of the present invention.

FIG. 7 is a perspective diagram showing an application scenario of the expandable portable power supply of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

### First Embodiment

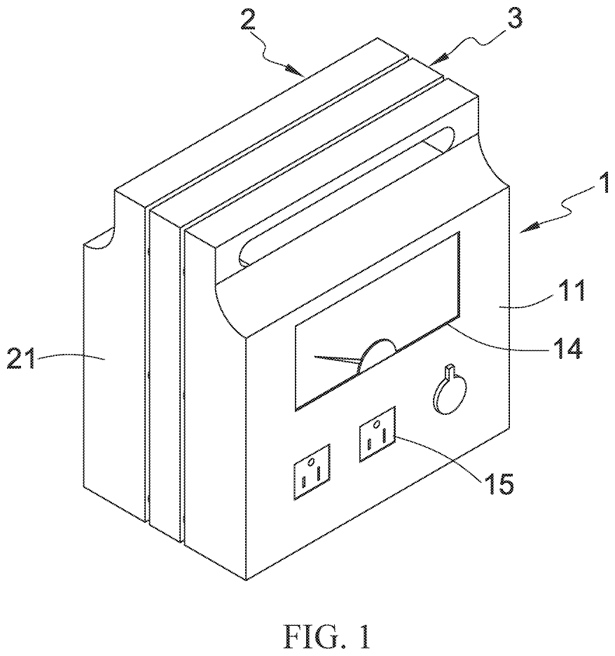

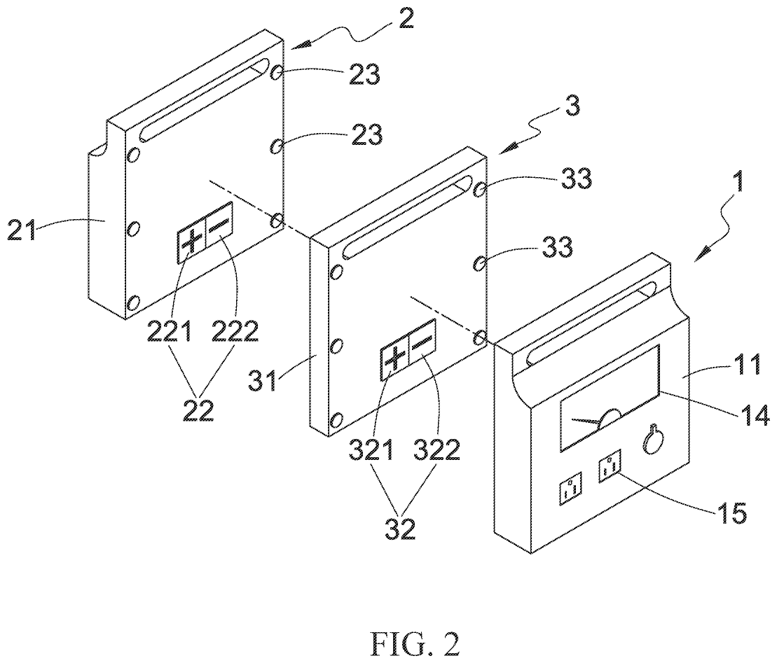

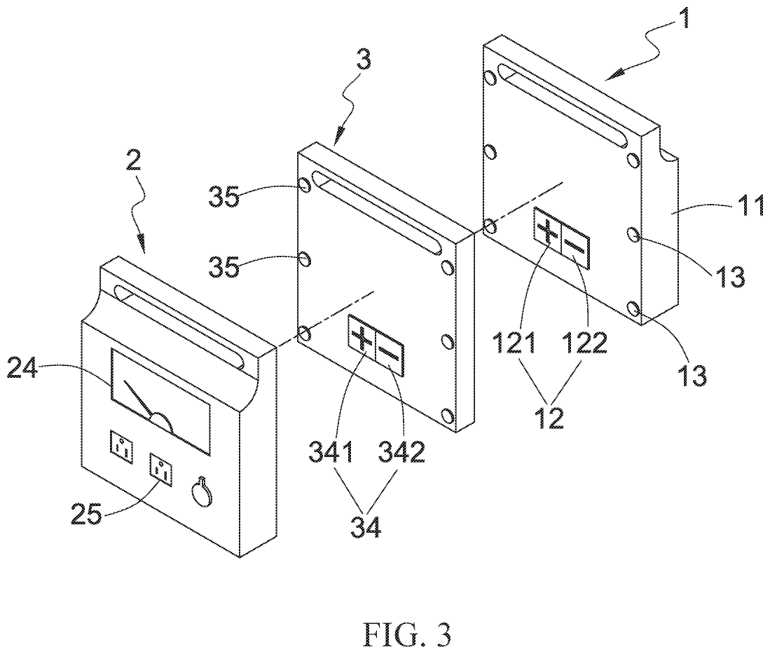

As shown in FIGS. 1 to 3, an expandable portable power supply according to a first embodiment of the present invention includes a first power source 1, a second power source 2, and an expansion power source 3.

The first power source 1 includes a first casing 11, and the first casing 11 has a first power connection member 12 and a first coupling member 13. Specifically, the first power connection member 12 includes a first positive connection element 121 and a first negative connection element 122. The first coupling member 13 includes a number of magnetic elements, buckling elements, screw fastening elements, or adhesive elements. The first casing 11 has a first display panel 14 and a first power source output element 15. An electronic device may be connected to the first power source output element 15 to receive electricity therefrom.

The second power source 2 is disposed to a side of the first power source 1. The second power source 2 includes a second casing 21, and the second casing 21 has a second power connection member 22 and a second coupling member 23. Specifically, the second power connection member 22 includes a second positive connection element 221 and a second negative connection element 222. The second coupling member 23 includes a number of magnetic elements, buckling elements, screw fastening elements, or adhesive elements. The second casing 21 has a second display panel 24 and a second power source output element 25. An electronic device may be connected to the second power source output element 25 to receive electricity therefrom.

The expansion power source 3 is sandwiched between the first power source 1 and the second power source 2. The expansion power source 3 includes an expansion casing 31. The expansion casing 31 has a third power connection member 32 and a third coupling member 33 on the first side, and the expansion casing 31 has a fourth power connection member 34 and a fourth coupling member 35 on a second side. Specifically, the third power connection member 32 includes a third positive connection element 321 and a third negative connection element 322. The fourth power connection member 34 includes fourth positive connection element 341 and a fourth negative connection element 342. The third coupling member 33 and the fourth coupling member 35 respectively include a number of magnetic elements, buckling elements, screw fastening elements, or adhesive elements.

To assemble the present embodiment, the first power source 1 and the expansion power source 3 are aligned and attached so that the first power connection member 12 and the third power connection member 32 are contacted, and the first coupling member 13 and the third coupling member 33 are matched and joined. Specifically, the first positive connection element 121 and the third negative connection element 322 are contacted, and the first negative connection element 122 and third positive connection element 321 are contacted. If the first coupling member 13 includes magnetic elements (or other type of elements), the third coupling member 33 should also be magnetic elements of opposite polarity (or other corresponding type of elements), so that the first coupling member 13 and the third coupling member 33 may reliably hold the first power source 1 and the expansion power source 3 together.

The second power source 2 and the expansion power source 3 are also aligned and attached so that the second power connection member 22 and the fourth power connection member 34 are contacted, and the second coupling member 23 and the fourth coupling member 35 are matched and joined. Specifically, the second positive connection element 221 and the fourth negative connection element 342 are contacted, and the second negative connection element 222 and the second positive connection element 341 are contacted. If the second coupling member 23 includes magnetic elements (or other type of elements), the fourth coupling member 35 should also be magnetic elements of opposite polarity (or other corresponding type of elements), so that second coupling member 23 and the fourth coupling member 35 may reliably hold the second power source 2 and the expansion power source 3 together.

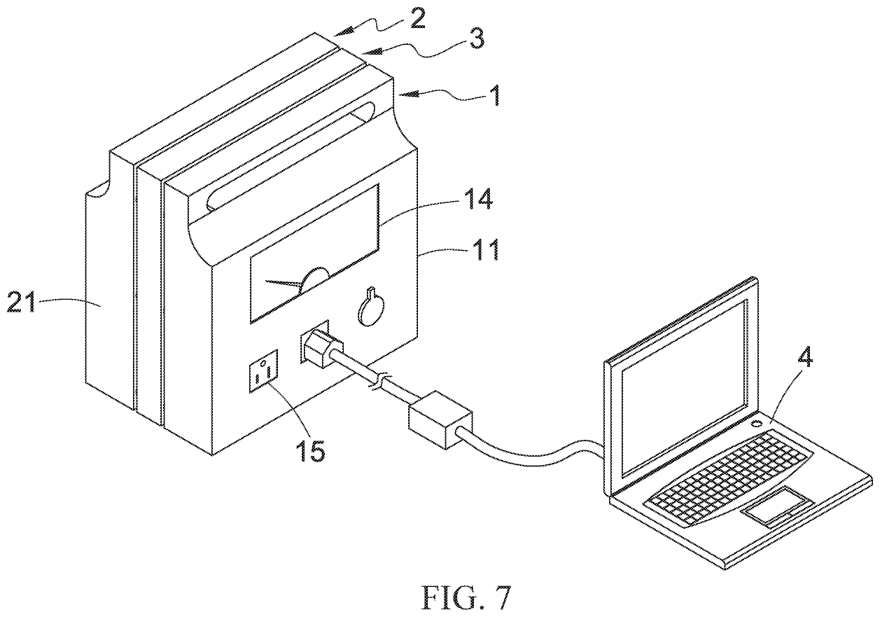

As shown in FIG. 7, an electronic device 4 may be connected to the first power source output element 15 to receive electricity from the expandable portable power supply.

### Second Embodiment

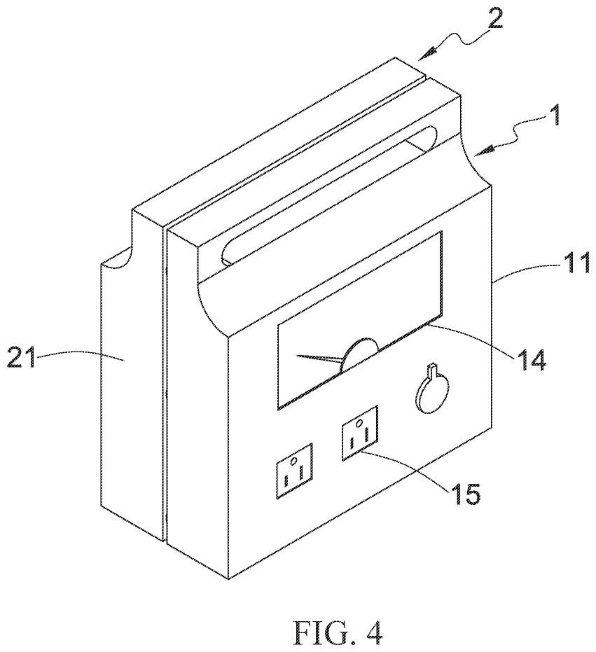

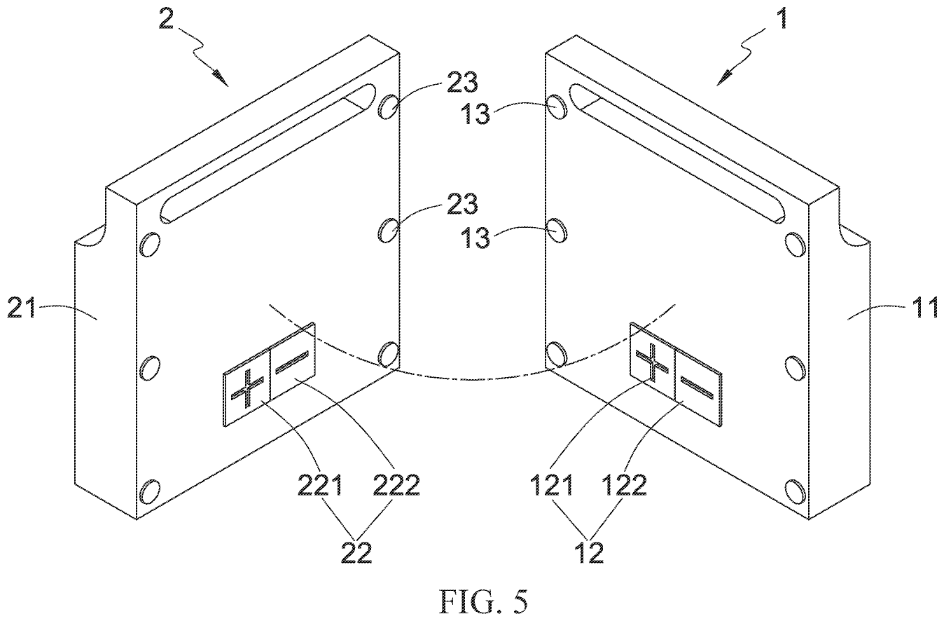

As shown in FIGS. 4 and 5, the present embodiment has the first power source 1 and the second power source 2 directly coupled together.

To assemble the present embodiment, the first power source 1 and the second power source 2 are aligned and attached so that the first power connection member 12 and the second power connection member 22 are contacted, and the first coupling member 13 and the second coupling member 23 are matched and joined. Specifically, the first positive connection element 121 and the second negative connection element 222 are contacted, and the first negative connection element 122 and the second positive connection element 221 are contacted. If the first coupling member 13 includes magnetic elements (or other type of elements), the second coupling member 23 should also be magnetic elements of opposite polarity (or other corresponding type of elements), so that the first coupling member 13 and the second coupling member 23 may reliably hold the first power source 1 and the second power source 2 together.

### Third Embodiment

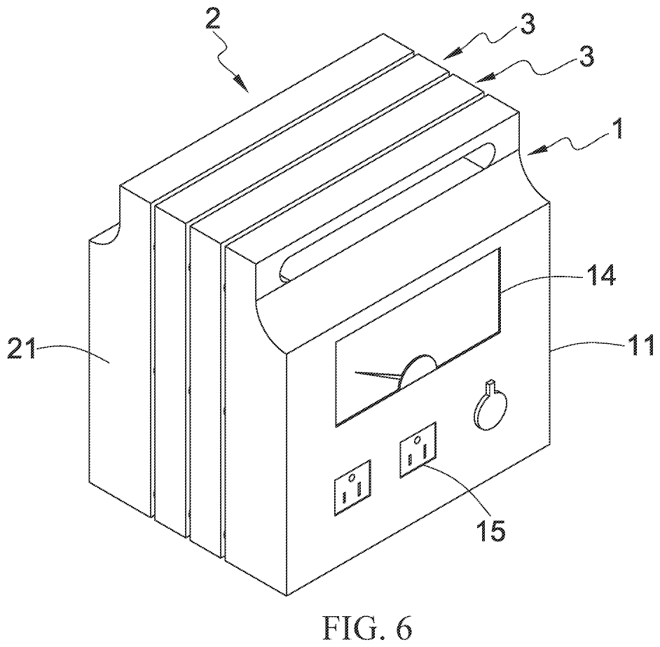

As shown in FIG. 6, the present embodiment has multiple expansion power sources 3 sandwiched between the first power source 1 and the second power source 2 to further increased the power capacity of the expandable portable power supply.

The present embodiment is similar to the first embodiment and the only difference lies in that there is a single expansion power source 3 in the first embodiment as shown in FIG. 1, whereas there are two expansion power sources 3 in the present embodiment as shown in FIG. 6. What is depicted in FIG. 6 is only exemplary and there could be, three, four, or even more expansion power sources 3 if required by demands.

As described above, the first power source 1 and the second power source 2 can be detachably coupled and their respective power capacities are combined, providing electricity to electronic devices for an extended period of time. The first power source 1 and the second power source 2 may be detached for easy transportation and replacement, especially convenient for camping, travel, or other outdoor activity.

Additionally, one or more expansion power sources 3 can be sandwiched between the first power source 1 and the second power source 2 for even greater combined power capacities.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An expandable portable power supply, comprising
a first power source comprising a first casing, where the first casing has a first power connection member and a first coupling member; and
a second power source disposed to a side of the first power source comprising a second casing, where the second casing has a second power connection member and a second coupling member;
wherein, when the first power source and the second power source are aligned and attached, the first power connection member and the second power connection member are contacted, and the first coupling member and the second coupling member are matched and joined.

2. The expandable portable power supply as claimed in claim 1, further comprising at least one expansion power source sandwiched between the first power source and the second power source; wherein the expansion power source comprises an expansion casing having a third power connection member and a third coupling member on a first side, and a fourth power connection member and a fourth coupling member on a second side.

3. The expandable portable power supply as claimed in claim 1, wherein the first power connection member comprises a first positive connection element and a first negative connection element; and the second power connection member comprises a second positive connection element and a second negative connection element.

4. The expandable portable power supply as claimed in claim 1, wherein each of the first coupling member, the second coupling member, the third coupling member, and the fourth coupling member comprises a plurality of magnetic elements, buckling elements, screw fastening elements, or adhesive elements.

5. The expandable portable power supply as claimed in claim 1, wherein the first casing of the first power source further comprises a first display panel and a first power source output element; and the second casing of the second power source further comprises a second display panel and a second power source output element.
